(19) United States
(12) Patent Application Publication
(10) Pub. No.: US 2009/0103178 A1
(43) Pub. Date: Apr. 23, 2009

(54) Stereoscopic Image Display Apparatus

(75) Inventors: Graham John Woodgate, Oxfordshire (GB); Jonathan Harrold, Warwickshire (GB)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/253,496

(22) Filed: Oct. 17, 2008

(30) Foreign Application Priority Data
Oct. 17, 2007 (GB) 0720282.3

(51) Int. Cl. G02B 27/26

(52) U.S. Cl. 359/465; 353/8; 349/15

(57) ABSTRACT

In the specification and drawing, a stereoscopic image display apparatus is described and shown with eyewear having a polarization interference filter, wherein the polarization interference filter can distinguish both polarization and spectra.

### RELATED APPLICATIONS

This application claims priority to British Application Serial Number 0720282.3, filed Oct. 17, 2007, which is herein incorporated by reference.

### BACKGROUND

1. Field of Invention

The present invention relates to an image display apparatus, more particularly, to a stereoscopic image display apparatus capable of displaying 3D stereoscopic images.

2. Description of Related Art

A stereoscopic display provides at least two distinct images to each eye of an observer wearing specific eyewear. However, for auto-stereoscopic displays, eyewear is not necessary. The brain fuses the images to give a sense of depth. An important factor, corresponding to viewing comfort when observing such displays, is the cross talk between the left and right images. High cross talk results in erroneous (pseudoscopic) homologous points in visualization, which may disrupt the human visual system. Acceptable cross talk, defined by the cross talk threshold, depends on the contrast of the image presented and the amount of depth to be shown. Cross talk of less than 1%-5% is often required for comfortable viewing while the cross talk threshold less than 0.5% has been reported. The visual effect of cross talk can be reduced by image contrast reduction, but image performance will degrade, and the contrast of edges in the scene is unclear, thus the stereoscopic image effect is worse.

Many stereoscopic displays have been demonstrated, including two color anaglyphs, shutter glasses, crossed polarization and multi-color anaglyph. In those stereoscopic displays, image data for left and right eyes provided by a display are appropriately encoded and later decoded with the eyewear. Stereoscopic displays are suited to large audiences. However, it would not be economic to provide separate auto-stereoscopic (glasses free) images to each member of the audience.

Two color anaglyph displays typically rely on broad spectral filters placed over each eye and provide a restricted color gamut seen in each eye. While the brain somewhat fuses and compensates for the color difference of the images, providing adequate color and intensity matching between the two eyes results in false depth cues and viewer discomfort becomes problematic.

Multi-color anaglyph, or ‘spectrally selective’ systems such as described in U.S. Pat. No. 7,001,021 seeks to overcome the difficulties of two color anaglyphs by presenting complementary comb spectra to each eye, such that the red, green and blue data of different respective spectra are received by each eye. Such displays are capable of transmitting full color images to each eye, with compensation for gamut and intensity differences achieved by processing source data. Cross talk in such displays is determined by the spectral separation ability between the left and right eye color bands.

The appropriate separation of the spectra can be achieved by vacuum deposited (isotropic) interference filters, or by polarization (birefringent) interference filters such as described in U.S. Patent Publication No. 2007/0188711. Cross talk performance of the display is determined by the quality of separation provided by the encoding and decoding filters. Isotropic interference filters can attain low cross talk, but have a high cost. These filters can also suffer from poor off-axis viewing meaning that the image cross talk, intensity and color gamut seen by each eye may vary depending on the viewing angle through the glasses.

The eyewear described above is passive, with no active component. Shutter glasses are active eyewear with switchable components. The shutter glasses such as described in U.S. Pat. No. 4,884,876 rely on the separation of left and right eye images in the time domain by opening and closing a shutter over each eye in synchronisation with the left and right images. When used in cooperation with fast response display systems such as the Texas Instrument DLP™ imager, such displays are capable of providing low cross talk. However, shutter glasses are relatively expensive, tend to be bulky, and require additional power sources and synchronization devices, and ambient light may result in distracting flicker of the shutter glasses.

Polarization systems such as described in U.S. Pat. No. 4,792,850 allow the use of passive glasses. In such a display, the polarization operation of a display is switched in synchronisation with the images generated by a display device, such as a CRT or DLP display. The glasses worn by the observer are of orthogonal polarization so that each eye may see a respective image. When polarization systems are used in projection, they rely on the use of a polarization preserving screen, such as a silvered screen. Achromatic switches are described in U.S. Pub. No. 2006/0291053. Such switches ensure the rotation of polarized light is substantially maintained across the visible spectrum. Performance of the system is limited by cross talk generated by depolarization at the polarization preserving screen.

U.S. Pat. No. 7,002,619 describes a dual projector display system seeking to overcome the problem with cross talk arising from light leakage in shutter glasses. Two projector systems suffer from high cost of projectors, and the difficulties in matching the alignment, intensity and color gamuts throughout the overall operation.

A conventional stereo display system is shown in FIG. 1. Image projectors 2 and 4 illuminate a projection screen 10 through polarizers 6 and 8 arranged to pass a portion of the respective images. The output polarization axis of polarizers 6 and 8 are orthogonal. The projection screen 10 has a polarization preserving property and directs the light back towards an observer (not shown) with passive eyewear 12 and 14. The eyewear 12 and 14 include polarizers respectively aligned to the polarizers 6 and 8.

Cross talk performance in such a display is dominated by the reflectivity of the projection screen. For example a depolarization ratio of 20:1 will create 5% cross talk. Such cross talk will cause visual stress for many users of stereoscopic displays, particularly for high contrast images.

FIG. 2 shows a time sequential projector, in which a projector 16 sequentially produces left and right images. A filter 18 includes a switchable polarization rotator. The eyewear passes left eye data through filter 12 and right eye data through filter 14 in sequence.

In spectrally selective systems, eyewear is designed to achieve adequate finesse so that the cross talk falls below an acceptable threshold. Eliminating the spectral overlap between the left and right eye spectra is essential. An isotropic interference filter suffers from high cost and variation of spectrum with different viewing angle. As the observer's eye deviates from the central position of the glasses, the spectrum also shifts. This may result in brightness variation, color variation, and cross talk increment. Such filters are typically formed in vacuum coating equipment and to achieve adequate spectral selectivity, a number of accurately tuned layers must be deposited. The high cost of such filters indicates they must be frequently re-used, and they are also sensitive to scratching during repeated heavy use and cleaning, such that the picture quality will degrade.

Eyewear using only polarization interference filters as the means of separation of left and right eye images requires complex retarder stacks incorporating large numbers of elements to achieve the adequate spectral selectivity; thus they also suffer from high cost.

FIG. 3 shows a conventional time sequential spectrally selective stereoscopic display. The color filter 20 includes a spinning isotropic interference filter wheel with left and right eye spectra. The spectral output is synchronised with the projector image 16. The screen 22 is a non-polarization preserving screen. The eyewear 24 and 26 comprise isotropic interference filters with spectra matching the filter 20 spectra. Transmission spectra for filter 20 are shown schematically in FIG. 4, which plots transmission 28 against wavelength 30. The first spectrum comprises blue, green and red transmission peaks 32, 34, and 36 respectively, while the second spectrum comprises blue, green and red transmission peaks 38, 40, and 42 respectively.

While multi-cavity designs adopt dielectric isotropic interference filters, Fabry-Perot filters and metal-dielectric filters, it is possible to achieve high image separation efficiency with low spectral cross talk. However, such filters are expensive to manufacture, and thus are typically required to be re-used. Such re-used filters require cleaning of the glasses to prevent biological contamination between users, and means that the glasses are prone to be scratched which can degrade image quality. Further, such glasses have off-axis viewing limitations in which the spectral peak shifts with viewing angles. That means that as the eyes of the observer look off axis through the filters 24 and 26, the position of the spectral peak shifts. This may not match the peak output spectrum of the projector, so that the brightness reduces, or the light through the first spectral filter may match the second spectrum, so the image cross talk increases.

For avoiding the disadvantages of implementing above filter, such as poor off-axis viewing, the image cross talk, intensity and color gamut seen by each eye varying in accordance with the viewing angle through the glasses, it is desired to provide a stereoscopic image display apparatus with improved image displaying ability and lower manufacturing cost.

### SUMMARY

Therefore, according to one aspect of the invention, a stereoscopic image display apparatus is provided to reduce image cross talk and present high quality images.

According to one embodiment of the present invention, a stereoscopic image display apparatus includes an image generation device, a color encoding device, a polarization encoding device, a first eyewear, and a second eyewear. The image generation device provides at least one first image and at least one second image. The color encoding device encodes the first image and the second image into a color-filtered first image having a first visible spectrum and a color-filtered second image having a second visible spectrum respectively, wherein the first visible spectrum is different from the second visible spectrum. The polarization encoding device polarizes the color-filtered first image and the color-filtered second image into a polarized first image having a first polarization state and a polarized second image having a second polarization state respectively, wherein the first polarization state is different from the second polarization state. The first eyewear has a first polarization interference filter for distinguishing the polarized first image from the polarized second image and for distinguishing the first visible spectrum from the second visible spectrum. The second eyewear has a second polarization interference filter for distinguishing the polarized second image from the polarized first image and for distinguishing the second visible spectrum from the first visible spectrum.

In one embodiment of the invention, the stereoscopic image display apparatus also includes a control device for controlling the image generation device, the color encoding device and the polarization encoding device.

With a first polarization interference filter, the first eyewear is capable of transmitting a portion of the first visible spectra and a less portion of the second visible spectra.

Similarly, with a second polarization interference, the second eyewear is capable of transmitting a portion of the second visible spectrum and a smaller portion of the first visible spectrum.

According to another embodiment of the invention, a multi-view stereoscopic display apparatus is provided to generate high quality multi-view stereoscopic images with reduced image cross talk.

In another embodiment of the invention, the multi-view stereoscopic display apparatus includes a direct view display device. The direct view display device has a backlight module, a display panel, and a plurality of horizontal strip regions. The backlight module is capable of providing backlight, the display panel is capable of displaying the first and second image, and the display panel has a plurality of displaying regions. The horizontal strip regions respectively arranged on the displaying regions.

The polarization filter of the embodiment is configured to filter a first image, a second image, and a third image respectively with at least two polarization states. And the control device is also configured to synchronize the images, the corresponding visible spectra, and corresponding polarization states.

Furthermore, a third eyewear is implemented to modulate the third image filtered by the color filter and the polarization filter with a third polarization interference filter. Thus, users can select the amount of depth required to present 3D stereoscopic images.

A display is capable of providing multi-view images such that observers can select whether they wish to view a 2D image, a low depth image or a high depth image. Advantageously, users can tune the direct view display to meet individual viewing comfort needs.

In the second embodiment, the display is capable of providing a sequence of polarized and color filtered images to the eyewear with retarder stacks capable of modulating polarized images. Such displays are well suited to be viewed by large audiences. The purpose of the embodiment for providing a stereoscopic display with low image cross talk and wide viewing angle using low cost passive glasses and simple polarization interference filters is thus achieved.

Real polarization preserving screens suffer from depolarization effects due to skew ray depolarization and surface scatter as well as from plasticizers used in the construction of the screen. The stereoscopic image display apparatus of the aforesaid embodiment is capable of maintaining image cross talk below a threshold with such screens.

Advantageously, the reflection profile of the screen may be modified to reduce the screen gain and thus decrease hot spots on the screen. Reducing the screen gain may increase the depolarization by the screen, however, the stereoscopic image display apparatus in the embodiments can maintain image cross talk below a threshold. Such screens may for example provide more acceptable performance when used in 2D projection mode.

Linearly polarized eyewear is sensitive to increased image cross talk resulting from head tilt. In order to overcome this problem, circular polarizers have been implemented, which typically create some chromaticity effects accompanying the head tilt.

The eyewear of aforesaid embodiments includes a pair of polarization interference filters each comprising an input and output polarizer and a small number of retarders in a stack such that the spectral transmission of the two glasses are different. Simple retarder stacks are cheaper to manufacture compared with complex retarder stacks required in prior art systems. Low image cross talk is partially achieved by the input polarizers of the two glasses aligned orthogonally with respect to each other, and a polarization filtering operation for the first and second images. As the width of the transmission spectrum for each peak is typically broader than conventional complex retarder stacks, the offset in the transmission spectrum produced by varying the viewing angle through the filter maintains an acceptable overlap with the spectrum output from the display for the respective image data.

Further, the spectral selectivity of the polarization interference filter can compensate for depolarization resulting from the screen and said polarizers. In one embodiment, to improve spectral angular performance further, simpler wide-field retarder stack architectures may be used than for known systems, reducing eyewear cost. The sensitivity of the eyewear to head tilts is thus reduced.

The polarization separation of the light from respective views entering the eyewear and the spectral overlap of the light entering the eyewear are individually above acceptable thresholds for comfortable viewing of images, for example greater than 1% luminance cross talk per color channel (red, green or blue) and typically greater than 2% luminance per color channel for polarization effects and greater than 5% luminance per color channel for color selectivity effects. In combination, the cross talk of the observed image falls below the acceptable threshold for cross talk, for example 1% luminance per color channel or less.

Such a display does not rely on high performance polarization switchers, high performance silvered screens or high performance isotropic interference or complex retarder stack polarization interference color selective eyewear. The system is tolerant to cross talk changes arising from head tilts using linear polarization filters and for high viewing angles.

Cross talk in screens arises from skew ray depolarization, and surface scatter for example due to surface contamination and the binder and plasticizer materials used to form the screen surface. Silvered screens tend to exhibit high screen gain causing hot spots in images. However, the stereoscopic image display apparatus provided in the aforesaid embodiments are capable of reducing the polarization performance requirements for the screen and maintaining low image cross talk with low cost eyewear. In this way, it is possible for the screen to achieve higher image performance, e.g., reducing the visibility of hot spots.

These and other features, aspects, and advantages of the present invention will become better understood with reference to the following description and appended claims.

### BRIEF DESCRIPTION OF THE DRAWINGS

The invention can be more fully understood by reading the following detailed description of the embodiment, with reference made to the accompanying drawings as follows:

FIG. 1 depicts a conventional projection system using fixed polarizing filters;

FIG. 2 depicts a conventional projection system using a switchable polarization rotator;

FIG. 3 depicts a conventional projection system using a color filter;

FIG. 4 depicts transmission spectra of the color filter of FIG. 3;

FIG. 5 depicts a stereoscopic image display apparatus with a projector according to a first embodiment of the invention;

FIG. 6 depicts an exemplary structure of a switchable polarization rotator of the projector in FIG. 5;

FIG. 7 is an on-axis spectrum provided by the switchable polarization rotator 48 of FIG. 6;

FIG. 8a depicts an example of left eyewear according to a first embodiment;

FIG. 8b depicts an example of right eyewear according to a first embodiment;

FIG. 8c depicts another example of left eyewear according to a first embodiment;

FIG. 8d depicts another example of right eyewear according to a first embodiment;

FIG. 9a depicts an on-axis transmission spectrum provided by the eyewear of FIG. 8a;

FIG. 9b depicts an on-axis transmission spectrum provided by the eyewear of FIG. 8b;

FIG. 9c depicts a further on-axis transmission spectrum provided by the eyewear of FIG. 8b;

FIG. 10 depicts a stereoscopic image display apparatus with two projectors according to a first embodiment of the invention;

FIG. 11a depicts an example of a stereoscopic image display apparatus with a direct view display according to a second embodiment of the invention;

FIG. 11b depicts another example of stereoscopic image display apparatus with a direct view display according to a second embodiment of the invention;

FIG. 12a depicts an example of a first set of eyewear of a multi-view stereoscopic image display apparatus according to a third embodiment of the invention; and

FIG. 12b depicts an example of a second set of eyewear of a multi-view stereoscopic image display apparatus according to a third embodiment of the invention.

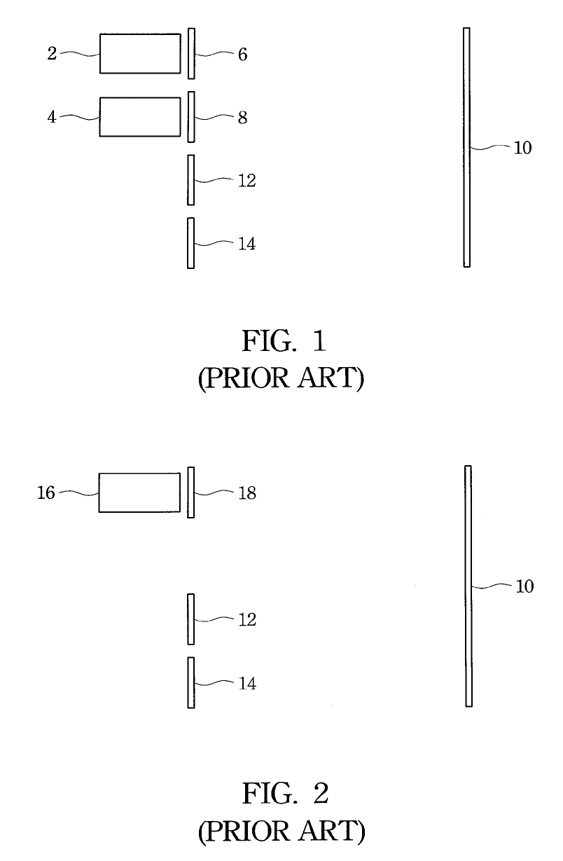

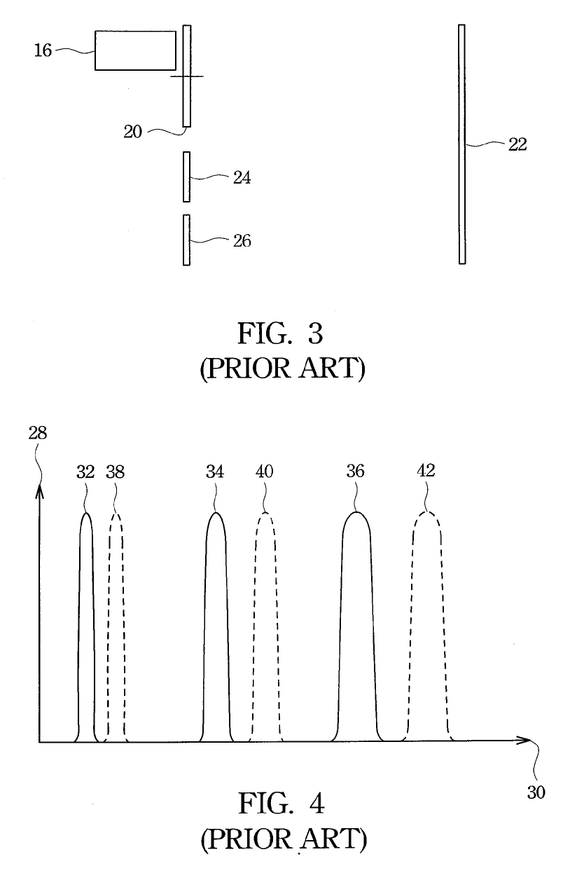

### DETAILED DESCRIPTION

Stereoscopic image display apparatus provided by embodiments may be implemented in computer monitors, projection systems, cinema including digital cinema, games apparatus, professional displays and 3DTV. The disclosed embodiments below relate generally to projection systems and direct view displays with improved performance by means of appropriate eyewear with certain optical architectures and techniques.

Cross talk in spectrally selective stereoscopic image display apparatus is determined by the overlap of distinct spectral bands for the left and right eyes so that the left eye sees right eye image data and the right eye sees left eye image data. To reduce cross talk, the spectral overlap between the left image and right image should be minimized.

Total spectral overlap can be defined as the luminance ratio of the incorrect spectrum to the correct spectrum passed by a spectral filter. Channel spectral overlap can be defined as the luminance ratio of the incorrect spectrum to the correct spectrum within a single color channel (red, green or blue). Average spectral overlap is an average of the channel spectral overlap for said three single color channels. Such values may take the illuminant property into account.

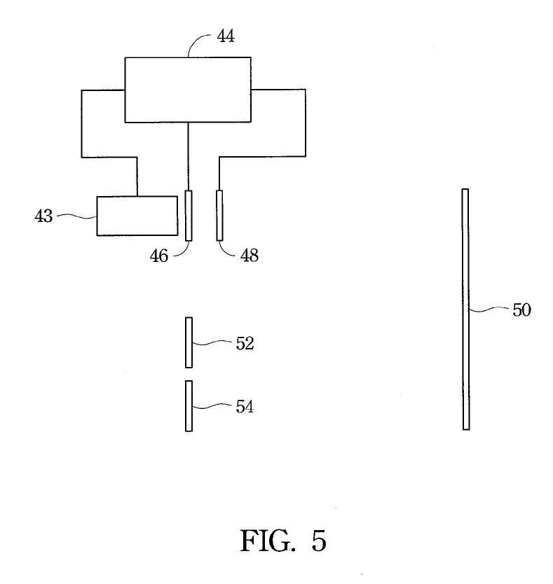

FIG. 5 shows a stereoscopic image display apparatus with a projector according to a first embodiment of the invention. The stereoscopic image display apparatus includes an image generation device such as a projector 43, capable of providing at least one left image and at least one right image, a color encoding device, such as a spectral selecting filter 46, capable of encoding the left image and the right image into a color-filtered left image having a first visible spectrum and a color-filtered right image having a second visible spectrum respectively, a polarization encoding device, such as a switchable polarization rotator 48, capable of polarizing the color-filtered left image and the color-filtered right image into a polarized left image having a first polarization state and a polarized right image having a second polarization state respectively, a left eyewear 52 for distinguishing the polarized left image from the polarized right image and for distinguishing the first visible image spectrum from the second visible image spectrum, and a right eyewear for distinguishing the polarized right image from the polarized left image and for distinguishing the second visible spectrum from the first visible spectrum. The first visible spectrum is different from the second visible spectrum, and the first polarization state is different from the second polarization state.

With the color encoding device and spectrally selective eyewear, separation of a first visible spectrum and a second visible spectrum may provide acceptable cross talk levels in isolation. However, the stereoscopic image display apparatus, implementing the polarization encoding device cooperating with the color encoding device, is capable of reducing cross talk below the cross talk threshold using low cost eyewear comprising polarization selective and spectrally selective elements.

The projector 46 generates left and right images with a field sequential method in synchronisation with a control signal received from a controller 44. The controller 44 also controls the spectral selecting filter 46 and the switchable polarization rotator 48.

The left image is generated in accordance with a first phase, the left image light then passes through the spectral selecting filter 46 and the switchable polarization rotator 48. The filtered light is later projected onto a screen 50 with partially polarization preservation properties. The reflected light is directed towards left eyewear 52 and right eyewear 54. The spectral selecting filter 46, the switchable polarization rotator 48, the left eyewear 52 and the right eyewear 54 will now be described in more detail.

The spectral selecting filter 46 may implement an isotropic interference filter, which demonstrates low levels of channel spectral overlap and thus low levels of cross talk. The isotropic interference filter may have two regions arranged on a single disk, and is configured to rotate in the optical path of the projector 46 operated in accordance with a sequential spectral selective method. On the other hand, the spectral selecting filter 46 may alternatively implement a birefringent interference filter to achieve appropriate separation of the spectra.

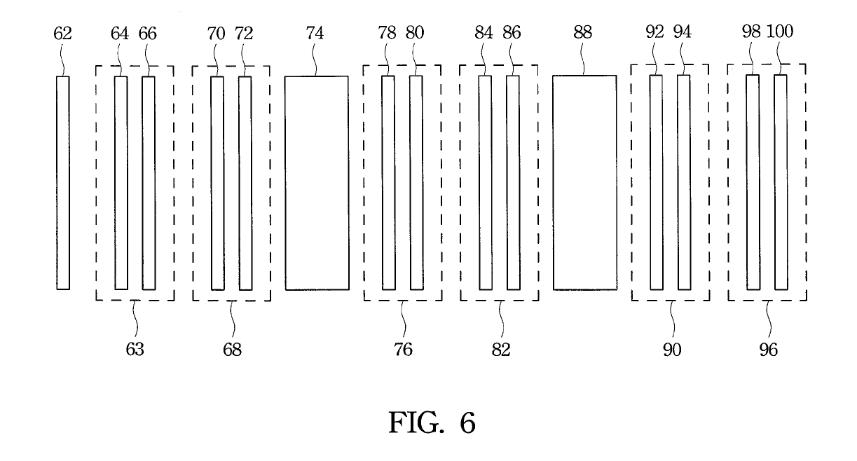

FIG. 6 shows an exemplary structure of a switchable polarization rotator of the projector in FIG. 5. The switchable polarization rotator 48 can be an achromatic push-pull polarization rotator. In the configuration of the achromatic push-pull polarization rotator, an linear input polarizer 62 is followed by a half wave rotator 63, a retarder stack 68, dynamic arrangement layers, such as a first zero twist nematic liquid crystal layer 74 and a second zero twist nematic liquid crystal layer 88 arranged to operate substantially in anti-phase to the first zero twist nematic liquid crystal layer 74, and a retarder stack 90. Each of the retarder stacks 68 and 90 has retarders, such as retarding films. Said retarder stacks are positioned at either side of first zero twist nematic liquid crystal layer 74 and second zero twist nematic liquid crystal layer 88 according to specific optical functions of the retarder stacks. The input polarizer 62 is linear, and the retarder stack 68 and retarder stack 90 both are arranged to compensate residual retardance. The retarder stacks 68,90 respectively comprise orthogonal retarding films 70,72 and 92,94 aligned to the layers 74,88 with retardances set to compensate for the residual retardance of the nematic liquid crystal mode in the high voltage state.

In the embodiment, the half wave rotator 63 includes retarders, such as retarding film, that is, a half wave retarding film 64 and a half wave retarding film 66 with predetermined angles so as to reduce dispersion to match the dispersion requirement of the of following retarder stacks during operation. Additional retarding film (not shown) may be included in the half wave rotator 63 to further improve the chromaticity of the stereoscopic image display apparatus. The first zero twist nematic liquid crystal layer 74 is arranged to provide a high retardance mode (low voltage) in accordance with the left image, and a low retardance mode (high voltage) in accordance with the right image. The second zero twist nematic liquid crystal layer 88 is correspondingly arranged to provide a low retardance mode (high voltage) in accordance with the left image, and a high retardance mode (low voltage) in accordance with the right image.

The retarder stack 68 includes retarding films 70 and 72 orthogonally arranged to each other. The retarder stack 90 includes retarding films 92 and 94 orthogonally arranged to each other. The retarding films 70, 72, 92 and 94 are aligned to the first zero twist nematic liquid crystal layer 74, and the second zero twist nematic liquid crystal layer 88 to compensate the retardance effect of these two zero twist nematic liquid crystal layers in the high voltage state.

The retarding films can also be positioned to both sides of the first zero twist nematic liquid crystal layer 74 and second zero twist nematic liquid crystal layer 88, such that the retarder stack 68 and the retarder stack 76 with half wave retarding film 78,80 near the first zero twist nematic liquid crystal layer 74 and the retarder stack 90 and the retarder stack 82 with half wave retarding film 84 and 86 near the second zero twist nematic liquid crystal layer 88 may cooperate to achieve a wider viewing angle.

In one example of the first embodiment, the switchable polarization rotator 48 is capable of providing substantially ±45 degree rotation in accordance with the left image and the right image with low spectral dispersion. The polarizing angle of the input polarizer 62 is 0 degrees, and half wave rotator 63 aligned with the input polarizer 62 and is capable of rotating the polarizaton state from the polarizer 62 to approximately 111.5 degrees. The axes of the first zero twist nematic liquid crystal layer 74 and the second zero twist nematic liquid crystal layer 88 respectively are aligned at 158.5 degrees and 111.5 degrees. The first zero twist nematic liquid crystal layer 74 and second zero twist nematic liquid crystal layer 88 are operated in anti-phase in accordance with the right image and left image, i.e. when one layer is relaxed, the other is driven and vice versa.

In certain conditions, a broadband quarter waveplate 96 having retarding films 98 and 100 is positioned ahead of the light-exiting side of the switchable polarization rotator 48 to provide achromatic circular polarization effect with similar chromatic performance to the broadband stack of layers 62,63,68,74,76,82,88,90 of FIG. 6.

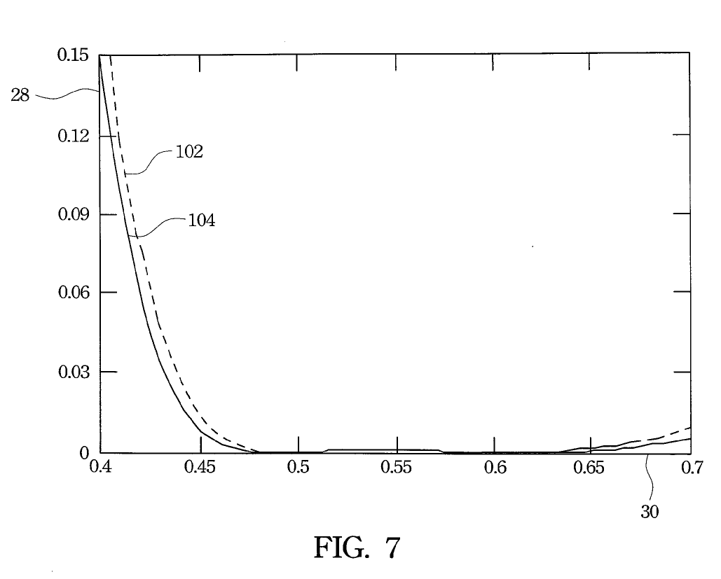

The on-axis spectrum provided by the switchable polarization rotator of FIG. 6 is shown in FIG. 7. The curve 102 and curve 104 respectively corresponding to the extinction levels for the left image and the right image are shown to be similar across the visible spectrum, so that cross talk due to polarization has nominally the same chromaticity for left and right eyes.

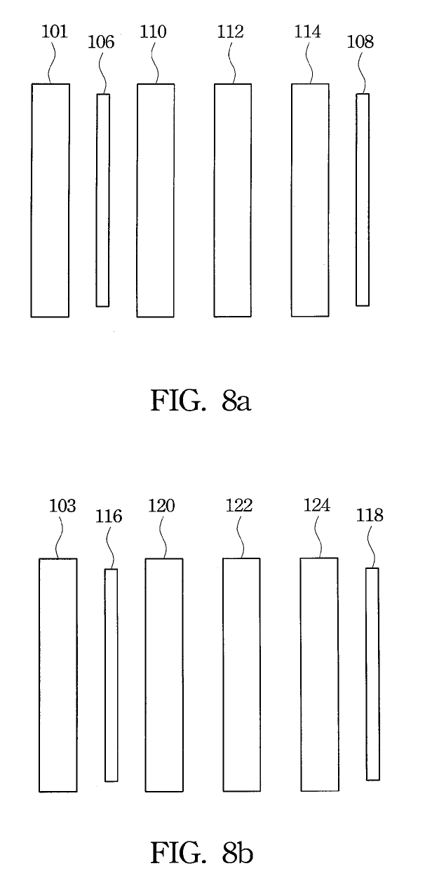

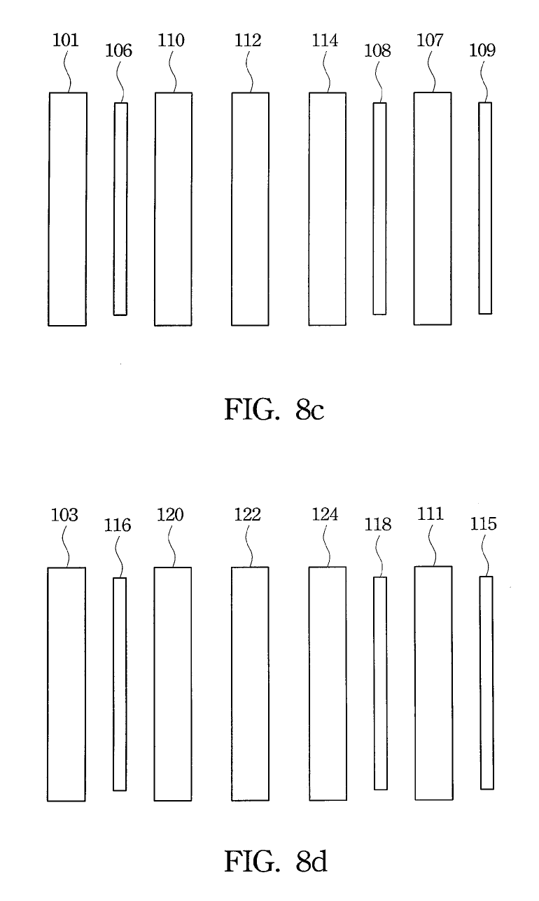

The degradation of polarization contrast between the right image and the left image resulting from the screen 50 is compensated by left eyewear 52 and right eyewear 54 as described below. FIG. 8a shows one example of left eyewear according to the first embodiment. The left eyewear 52 and right eyewear 54 each includes a polarization interference filter as shown in FIG. 8a. In the configuration of the polarization interference filter, an input polarizer 106 of the eyewear receives light from the screen, and the transmission axis of the input polarizer 106 is aligned with the polarization axis of the switchable polarization rotator 48 for the left image. An output polarizer 108 polarizes the left image seen by the viewer and is arranged orthogonally with the input polarizer 106. The retarder stack between the input polarizer 106 and output polarizer 108 has identical retarding films 110 and 114 aligned at 45 degrees to the input polarizer 106, and a retarding film 112 is sandwiched between the retarding films 110 and 114, and aligned parallel to the input polarizer. In the example, the retarding film 112 is capable of providing a quarter wave less retardation. The retarding films 110 and 114 may be identical.

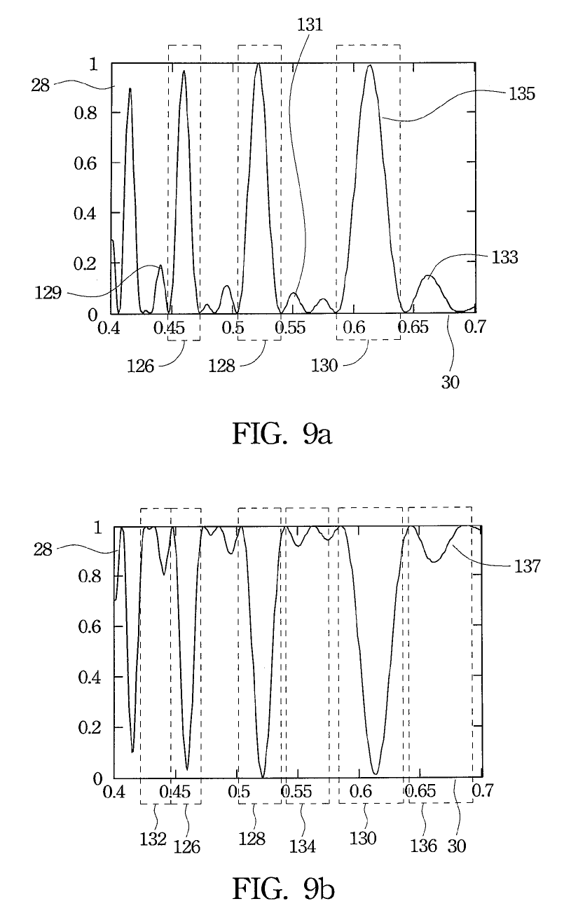

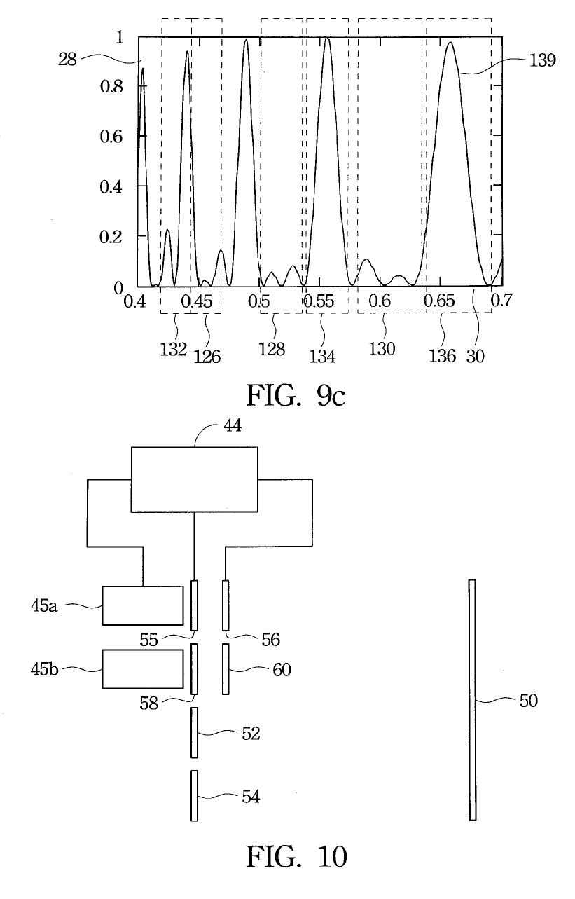

With appropriate retardance, the retarder stack may produce an on-axis transmission spectrum 135 as shown in FIG. 9a.

The present invention advantageously uses a simple retarder stack in a polarization interference low order ripple filter in combination with orthogonal input polarizers to produce a low cross talk system at low cost for the glasses. The spectrum of the left image processed with the spectral selecting filter 46 includes a blue region 126, a green region 128 and a red region 130 distinguished with maximum transmission. Overlap of the spectrum 137 with regions 126,128 and 130 can be observed. Similarly overlap of the spectrum 135 with the regions 132, 134 and 136 will occur.

The implementation of the low order ripple filter indicates that there are peaks 129, 131 and 133 existing in the on-axis transmission spectrum 135 and falling outside the blue region 126, the green region 128 and the red region 130. In particular, values of these spectral peaks are greater than 5% of the maximum of the on-axis transmission spectrum 135. In other examples, there may be at least four spectral peaks in each eyewear, and it is possible to discover six or more spectral peaks across the on-axis transmission spectrum with eyewear implementing the low order ripple filter.

The first blue channel spectral cross talk is contributed by light around wavelength maximum 129, and around maxima 131 and 133 for green and red channels respectively. The luminance of the first image in the blue color channel can be calculated for example by the overlap of the spectrum 135 with the light from the display with spectrum in the blue region 126.

In the example, the right eyewear 54 of FIG. 5 is shown in FIG. 8b. The right eyewear has a second polarization interference filter. The second polarization interference filter includes an input polarizer 116, a retarder stack with retarding films 120,122 and 124. In one embodiment, the retarding films 120,122 and 124 can have identical optical characteristic with that of the retarding films 110,112 and 114. The polarizer 118 is parallel to the polarizer 108. In the example, an on-axis transmission spectrum 137 provided by the right eyewear is shown in FIG. 9b. The spectrum of the right image processed with the spectral selecting filter 46 includes a blue region 132, a green region 134 and a red region 136 distinguished with maximum transmission. Overlap respectively between the blue regions 126 and 132, the green regions 128 and 134, and the red regions and 130 and 136 can be observed.

The output polarisers 108, 118 of the first and second interference filters are normally orthogonal or parallel to the respective input polarisers 106, 116. However, the input and output polarisers may alternatively be at other relative angles. The retarder stacks 110,112,114 and 120,122,124 may be modified accordingly. Such arrangements may advantageously be used to fine tune the spectral distinguishing properties of the respective polarisation interference filters. The angle between the input and output polarisers could be for example 45 degrees by adjusting the retardance of the respective retarder stacks.

In FIGS. 8a and 8c retarder 101 can be positioned at the light-receiving side of the input polarizer 106 of the left eyewear and in FIGS. 8b and 8d retarder 103 can be positioned at the light-receiving side of the input polarizer 116 of the right eyewear. Such retarders when used in combination with a circular polarisation encoding device enables a system with circularly polarized light that is tolerant to head tilt. The stereoscopic image display apparatus may process the left image and right image with orthogonal circular polarizations. The retarders 101,103 may be quarter waveplate retarding films or may be retarder stacks so as to provide wideband achromatic quarter waveplates. The combination of retarder 101 and linear polariser 106; and retarder 103 and linear polariser 116 are termed circular polarisers. The transmission axis of a circular polariser may be defined as the axis of transmission of the linear polarisation that emerges.

However, the cross talk between the left eyewear and right eyewear of FIG. 8a and FIG. 8b is above the crosstalk threshold, but crossed polarization states provided by the input polarizers 106 and 116 indicate that it is possible to reduce the cross talk between the left eyewear and right eyewear below the cross talk threshold.

In different examples, the output polarizer 118 is arranged orthogonally to the input polarizer 116 and thickness of the retarding films 110,112 and 114 is adjusted, such that a on-axis transmission spectrum 139 acquired is shown in FIG. 9c. Overlaps between the on-axis transmission spectrum 139 and the blue region 132, green region 134 and red region 136 can be observed. Comparing with the overlap between the blue region 132, green region 134 and red region 136, overlap between the on-axis transmission spectrum 139 with the blue region 126, the green region 128 and the red region 130 become less.

Thus, the right eyewear transmits a significant portion of a right visible spectrum with the blue region 132, the green region 134 and the red region 136, and the right eyewear also transmits a lesser, but non-zero, portion of the left visible spectrum with the blue region 126, the green region 128 and the red region 130.

Similarly, the left eyewear transmits a significant portion of the first visible spectrum with the blue region 126, the green region 128 and the red region 130. The left eyewear also transmits a lesser, but non-zero, portion of the second visible spectrum with the blue region 132, the green region 134 and the red region 136.

This significant transmission of a lesser proportion of the opposite coding spectrum would provide unacceptable cross talk levels in isolation, but the polarization coding of the image means that cross talk below the cross talk threshold is achieved using low cost eyewear.

The chromaticity of the stereoscopic image display apparatus is determined in consideration of the blue regions 126 and 132, the green regions 128 and 134, and the red regions 130 and 136.

In another example, a filter 46 comprising a spinning color filter wheel comprising two regions of isotropic color filter each with four cavities has an on-axis spectral separation ability of 1000:1 between a first visible spectra and a second visible spectra. The color filter is manufactured with a vacuum deposition method. An achromatised push-pull linear polarization rotator replacing the switchable polarization rotator 48 modifies the output polarization state as shown in FIG. 7. The push-pull polarization rotator is also linear and achromatised. The screen, which the polarized images are incident on, has a reflected contrast ratio of 20:1. Thus, with polarizers of each eyewear aligned vertically to each other, cross talk between the left image and right image will be about 5%. As shown in FIG. 9a and FIG. 9c, the average spectral overlap for each eyewear of FIG. 8a and FIG. 8b is about 6% and 12% respectively. With operations of the projector, the spectrally selective filter, and the switchable polarization rotator being determined, the average system cross talk for the left image and right image is thus reduced to 0.3% and 0.6%. In a case of cross talk threshold being 1%, the average spectral overlap in the example is above the threshold, while the average system cross talk meets visibility requirements. The stereoscopic image display apparatus can thus provide high quality stereoscopic images with low cost eyewear.

Clearly, some enhancement of the filter performance can further reduce the filter overlap, but at the expense of significant additional retarder layers and therefore expense of glasses. In an alternative embodiment, width of the a blue region 126, a green region 128 and a red region 130, a blue region 132, a green region 134 and a red region 136 can be reduced to improve cross talk by means of removing peaks of these regions to prevent overlapping with the on-axis transmission spectrum 135 and 137.

In other examples, a blue cut-off filter or suitable retarder stacks can be arranged to sufficiently remove adjacent peaks around the blue region, thus channel spectral overlap for blue is improved by means of the eyewear. For example, as shown in FIG. 8c, an output polarizer 109 is inserted at a light-exiting side of the output polarizer 108, and a retarding film 107 is inserted between the output polarizer 108 and the output polarizer 109. Similarly, in FIG. 8d, an output polarizer 115 is inserted at a light-exiting side of the output polarizer 118, and a retarding film 111 is inserted between the output polarizer 118 and the output polarizer 115.

The retarders responsible for defining the spectral characteristics of the transmission may be referred to as spectral retarders, while the additional retarders inserted to enhance the field of view of the stack may be referred to as wide-field retarders. The function of such retarders may be combined to provide overall enhancement of performance. In the example, the polarization interference filters of eyewear implements retarder stacks includes low order ripple filters and polarizers orthogonally arranged, such that it is possible to manufacture the stereoscopic image display apparatus with reduced crosstalk at low cost.

Referring to FIG. 10, which shows a stereoscopic image display apparatus with two projectors according to a first embodiment of the invention. The stereoscopic image display apparatus implements the projector 45a and projector 45b to generate the left image and right image, which are later projected on the screen 50. A color encoding device 55, a color encoding device 58, a polarization encoding device 56 and a polarization encoding device 60 are fixed in specific positions. The brightness of the left image and the right image is increased.

The stereoscopic image display apparatus of the example requires robust alignment and matching of the projectors 45a, 45b. Further, as a sequence of the left image and the right image are continuously displayed, flicker artefacts provided by the projector 45a and the projector 45b are less sensitive to the viewer. The color encoding device 55 and the polarization encoding device 56 may be aligned within the optical path of the of the projector 45a and the color encoding device 58 and the polarization encoding device 60 may be aligned within the optical path of the projector 45b and the polarization encoding devices 56 and 60 may comprise the different output polarization states of the respective projector.

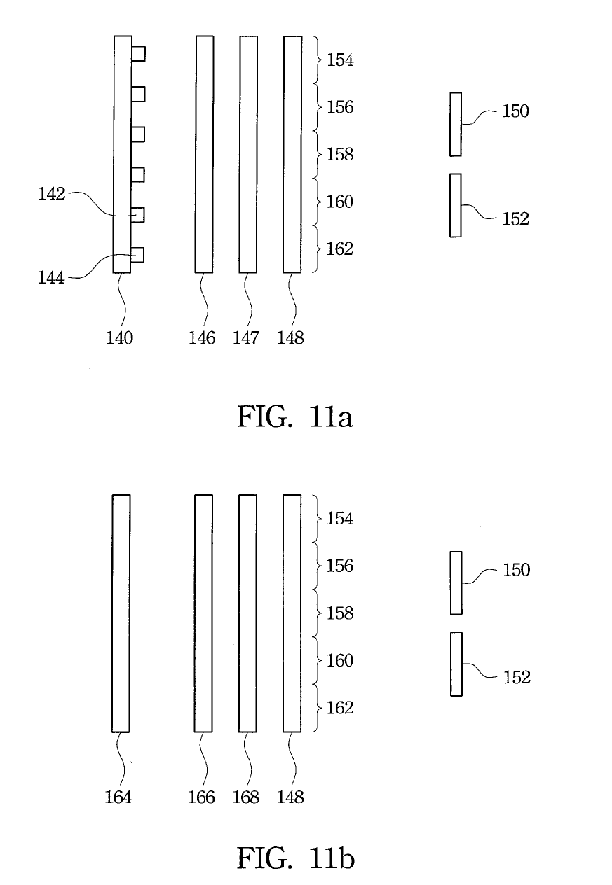

FIG. 11a shows an example of a stereoscopic image display apparatus with a direct view display according to a second embodiment of the invention. The direct view display includes a backlight module 140 with a light source 142 and light source 144. The light source 142 and the light source 144 respectively generate light with the first and second visible spectra. The light source 142 and the light source 144 may comprise LEDs, polarizers and retarder stacks to enhance the polarization interference selectivity effect. In other examples, tuned laser sources are alternatively implemented by the light source 142 and the light source 144.

A fast response transmissive display 146, such as a bend compensated liquid crystal display, receives light from the backlight module 140 to present images in synchronisation with operation of the light source 142 and light source 144. The fast response transmissive display 146 is capable of transferring light emitting from the light source 142 and light source 144 respectively into the left image and the right image.

The direct view display also includes an output polarizer 147 and a polarization switcher 148. The polarization switcher 148 is positioned in front of the output polarizer 147, and operates in synchronisation with the fast response transmissive display 146, the light source 142 and the light source 144. The eyewear 150 and eyewear 152 of the direct view display both have polarizers arranged orthogonally and polarization interference filters for spectral separation of the left image and right image as described above. The polarization switcher 148 with a shutter arranged in may be arranged in horizontal stripe regions 154-162 to switch a sequence of images generated by the fast response transmissive display 146 in synchronisation with image data processed as well known in the art.

The direct view display of the second embodiment increases the selectivity of the corresponding images. With fewer retarding films implemented in the eyewear 150 and the eyewear 152, a direct view display with low crosstalk can be manufactured with a lower cost.

FIG. 11b shows another example of stereoscopic image display apparatus with a direct view display according to the second embodiment of the invention. In the example, the direct view display includes an emissive display 164. Light from the display is incident on a spectrally selective filter 166 and a switchable polarization rotator 168. The switchable polarization rotator 168 has a retarder stack, a polarization switch, an input polarizer and an output polarizer. The polarization switcher 148 is positioned in front of the switchable polarization rotator 168, and operates in synchronisation with the emissive display 164, the spectrally selective filter 166 and the switchable polarization rotator 168. The spectrally selective filter 166 and the switchable polarization rotator 168 are configured to produce a sequence of left and right images with different visible spectra and polarization states, and viewer can watch the stereoscopic images by means of the eyewear 150 and the eyewear 152 described above.

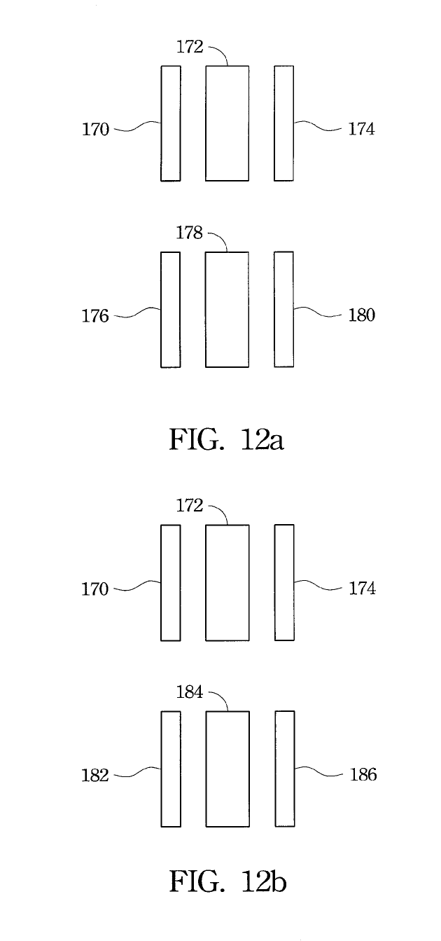

FIG. 12a shows an example of a first set of eyewear of a multi-view stereoscopic image display apparatus according to a third embodiment of the invention. In the example, a first set of eyewear has a first eyewear and a second eyewear respectively including a polarization interference filter. The first eyewear has an input polarizer 170, a retarder stack 172 and an output polarizer 174, which cooperate to transmit images with a first polarization state and a first visible spectrum. The second eyewear includes an input polarizer 176, a retarder stack 178 and an output polarizer 180. A transmission axis of the output polarizer 176 is aligned orthogonally with that of the input polarizer 170. The retarder stack 178 is identical with the retarder stack 172, but also oriented orthogonally. Thus, the viewer may watch orthogonally polarized images with the same visible spectrum.

FIG. 12b shows an example of a second set of eyewear of a multi-view stereoscopic image display apparatus according to a third embodiment of the invention. The second set of eyewear has the first eyewear and a third eyewear respectively including a polarization interference filter. The third eyewear includes an input polarizer 182 aligned orthogonally to the input polarizer 170, a retarder stack 184 and an output polarizer 186, which cooperate to transmit images with a polarization state the same as transmitted by polarizer 176 and with a second visible spectrum, different to the visible spectrum transmitted by the eyewear in FIG. 12a.

In the example, a stereoscopic image display apparatus corresponding to the first and second set of eyewear is capable of producing three images. A first image with a first visible spectrum and a first polarization state passes through the first eyewear, a second image with a first visible spectrum and a second polarization state passes through the second eyewear and a third image with a second visible spectrum and a second polarization state passes through the third eyewear. The second polarization state is orthogonal to the first polarization state. With such manner, three images can be directed towards a viewer. Advantageously, the viewer can select depth effect of 3D images they would like.

For example, adults may preferably view high depth images, while children (with a lower interocular separation) are encouraged to view lower depth images. Alternatively, experienced users may prefer high depth images, while less experienced users may prefer lower depth ranges for increased comfort. The first image can be a common image, while the second and third images may present different amounts of disparity to the audience. Advantageously, the disparity difference between the second and third image may be low so that higher levels of cross talk may be acceptable between these two image channels. In this way, the spectral filter design may have high ripple, reducing device cost.

Moreover, if observers wish to view a 2D image, then they may wear the same filter in each eye. Alternatively, the transmission spectra of the first and second eyewear may be different to show two sets of stereoscopic images.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A stereoscopic image display apparatus comprising:
an image generation device for providing at least one first image and at least one second image;
a color encoding device for encoding the first image and the second image into a color-filtered first image having a first visible spectrum and a color-filtered second image having a second visible spectrum respectively, wherein the first visible spectrum is different from the second visible spectrum;
a polarization encoding device for polarizing the color-filtered first image and the color-filtered second image into a polarized first image having a first polarization state and a polarized second image having a second polarization state respectively, wherein the first polarization state is different from the second polarization state;
a first eyewear comprising a first polarization interference filter for distinguishing the polarized first image from the polarized second image and for distinguishing the first visible spectrum from the second visible spectrum; and
a second eyewear comprising a second polarization interference filter for distinguishing the polarized second image from the polarized first image and for distinguishing the second visible spectrum from the first visible spectrum.

2. The stereoscopic image display apparatus of claim 1, wherein the first polarization interference filter comprises:
a first input polarizer having a transmission axis;
a first output polarizer having a transmission axis orthogonal to the transmission axis of the first input polarizer; and
a first retarder stack between the first input polarizer and the first output polarizer.

3. The stereoscopic image display apparatus of claim 2, wherein the second polarization interference filter comprises:
a second input polarizer having a transmission axis orthogonal to the transmission axis of the first input polarizer;
a second output polarizer having a transmission axis parallel to the transmission axis of the second input polarizer; and
a second retarder stack between the second input polarizer and the second output polarizer, wherein the second retarder stack and the first retarder stack are substantially identical.

4. The stereoscopic image display apparatus of claim 3, wherein the first input polarizer and the second input polarizer are linear polarizers, and the first polarization state and the second polarization state are linear polarization states.

5. The stereoscopic image display apparatus of claim 3, wherein the first input polarizer and the second input polarizer are circular polarizers, and the first polarization state and the second polarization state are circular polarization states.

6. The stereoscopic image display apparatus of claim 2, wherein the second polarization interference filter comprises:
a second input polarizer having a transmission axis orthogonal to the transmission axis of the first input polarizer;
a second output polarizer having a transmission axis orthogonal to the transmission axis of the second input polarizer; and
a second retarder stack between the second input polarizer and the second output polarizer, wherein the second retarder stack and the first retarder stack have different retardations.

7. The stereoscopic image display apparatus of claim 6, wherein the first input polarizer and the second input polarizer are linear polarizers, and the first polarization state and the second polarization state are linear polarization states.

8. The stereoscopic image display apparatus of claim 6, wherein the first input polarizer and the second input polarizer are circular polarizers, and the first polarization state and the second polarization state are circular polarization states.

9. The stereoscopic image display apparatus of claim 6, further comprising:
a third eyewear comprising a third polarization interference filter for transmitting a third image with a third polarization state and a third visible spectrum, wherein the third polarization interference filter comprises:
a third input polarizer having a transmission axis orthogonal to the transmission axis of the first input polarizer;
a third output polarizer; and
a third retarder stack between the third input polarizer and the third output polarizer, wherein the arrangement of the third retarder stack and the third output polarizer is different from the arrangement of the second retarder stack and the second output polarizer such that the third visible spectrum is different from the second visible spectrum.

10. The stereoscopic image display apparatus of claim 9, wherein the arrangement of the third retarder stack and the third output polarizer is different from the arrangement of the first retarder stack and the first output polarizer such that the third visible spectrum is different from the first visible spectrum.

11. The stereoscopic image display apparatus of claim 1, further comprising:
a control device for controlling the image generation device, the color encoding device and the polarization encoding device.

12. The stereoscopic image display apparatus of claim 1, wherein the image generation device comprises:
a screen; and
a projector for sequentially projecting the first image and second image onto the screen.

13. The stereoscopic image display apparatus of claim 1, wherein the image generation device comprises:
a screen;
a first projector for projecting the first image onto the screen; and
a second projector for projecting the second image onto the screen.

14. The stereoscopic image display apparatus of claim 1, wherein the color encoding device comprises:
a first light source for providing a first filtered light; and
a second light source for providing a second filtered light.

15. The stereoscopic image display apparatus of claim 14, wherein the image generation device comprises:
a display panel for transferring the first filtered light and the second filtered light into the first image and the second image respectively.

16. The stereoscopic image display apparatus of claim 1, wherein the polarization encoding device comprises:
a plurality of dynamic arrangement layers operating between different retardance modes in turn; and
a plurality of retarder stacks aligned with the dynamic arrangement layers.

17. The stereoscopic image display apparatus of claim 16, wherein the dynamic arrangement layers each comprises at least one liquid crystal layer.

18. The stereoscopic image display apparatus of claim 17, wherein the liquid crystal layers of the dynamic arrangement layers are operated in anti-phase.

19. The stereoscopic image display apparatus of claim 16, wherein the retarder stacks are respectively positioned at the light-entering side and the light-exiting side of the dynamic arrangement layers.

20. The stereoscopic image display apparatus of claim 16, wherein the retarder stacks each comprises:
two retarders oriented orthogonally to each other.

21. The stereoscopic image display apparatus of claim 1, wherein the first polarization interference filter and the second polarization interference filter each comprises an input polarizer, an output polarizer and a retarder stack between the input polarizer and the output polarizer, wherein the input polarizer of the first polarization interference filter has a transmission axis orthogonal to the transmission axis of the input polarizer of the second polarization interference filter.
